(19) United States
(12) Patent Application Publication
(10) Pub. No.: US 2018/0266481 A1
(43) Pub. Date: Sep. 20, 2018

(54) POWER TRANSMISSION SYSTEM

(71) Applicant: HONDA MOTOR CO., LTD., Tokyo (JP)

(72) Inventors: Sachi Fujinuma, Wako-shi (JP); Masato Takaya, Wako-shi (JP); Kenji Niwata, Wako-shi (JP)

(73) Assignee: HONDA MOTOR CO., LTD., Tokyo (JP)

(21) Appl. No.: 15/922,040

(22) Filed: Mar. 15, 2018

(30) Foreign Application Priority Data
Mar. 15, 2017 (JP) 2017-050468

(51) Int. Cl. F16C 17/04; B60K 17/35; F16H 48/42; F16H 48/08; F01D 25/18; F04D 29/051

(52) U.S. Cl. CPC F16C 17/045; B60K 17/3515; F16H 48/42; F16H 2048/082; F01D 25/186; F04D 29/0513; F16H 2048/423; F16H 48/08

(57) ABSTRACT

A power transmission system includes a first rotating shaft and a second rotating shaft, a first fastening element including multiple first friction members and rotating integrally with the first rotating shaft, a second fastening element including multiple second friction members and rotating integrally with the second rotating shaft, a frictional engagement portion in which the first fastening element and the second fastening element are alternately stacked in an axial direction, and a pressing member disposed movable in the axial direction and pressing the frictional engagement portion to engage the first friction members and the second friction members with each other. The first fastening element is supported in the axial direction by an internal thrust bearing and an external thrust bearing that have different diameters.

### CROSS REFERENCES TO RELATED APPLICATIONS

The present application claims priority under 35 U.S.C. § 119 to Japanese Patent Application No. 2017-050468, filed Mar. 15, 2017, entitled “Power Transmission System.” The contents of this application are incorporated herein by reference in their entirety.

### BACKGROUND

### 1. Field

The present disclosure relates to a power transmission system that supports the load of fastening elements, which are rotating bodies, in an axial direction using thrust bearings.

### 2. Description of the Related Art

As described in Japanese Patent Application Publication No. 2014-177980 or 2014-206227, examples of automobile power transmission systems include an automobile power transmission system including a clutch mounted on the outer circumference of a rotating shaft. The power transmission system described in Japanese Patent Application Publication No. 2014-177980 or 2014-206227 includes a clutch capable of switching between transmitting or stopping transmitting rotation between two rotating shafts coaxially arranged. The clutch includes a clutch guide, serving as a fastening element fixed to one of the rotating shafts, and a clutch hub, serving as a fastening element fixed to the other rotating shaft on the inner periphery of the clutch guide. The clutch also includes a frictional engagement portion in the clutch guide. The frictional engagement portion includes multiple friction members fixed to the clutch guide and multiple friction members fixed to the clutch hub, which are alternately stacked in the axial direction.

The above clutch also includes a piston member, which presses the frictional engagement portion in the direction in which the friction members are stacked, a piston guide, which houses the piston member, and a piston chamber, which is defined by the piston member in the piston guide and in which a hydraulic pressure that drives the piston member toward the frictional engagement portion is produced. The clutch engages, when the piston member is driven by the hydraulic pressure produced in the piston chamber to press and cause the frictional engagement portion to engage.

In the above clutch, when the piston member presses the frictional engagement portion, the clutch guide facing the piston member is pressed with the frictional engagement portion interposed therebetween. As in the case of Japanese Patent Application Publication No. 2014-177980 or 2014-206227, thus far, the load from the piston member in the axial direction has been supported by a single thrust bearing having a small diameter disposed in the clutch guide.

When the diameter of the clutch guide and the diameter of the thrust bearing having a small diameter differ from each other, the clutch guide may partially bend when receiving the pressing force from the piston member, and the clutch guide may have its axis inclined. When the clutch guide has its axis inclined and the relative axis inclination between the clutch guide and the clutch hub increases, noises may occur.

### SUMMARY

The present application describes a power transmission system that prevents the axis of a fastening element from being inclined with respect to its axis of rotation and prevents noises that can result from the axis inclination.

A power transmission system (for example, a clutch device 5 according to an embodiment) according to an embodiment includes a first rotating shaft (for example, a center shaft 4 according to an embodiment) and a second rotating shaft (for example, an output shaft 6 according to an embodiment), which have a common axis of rotation, a first fastening element (for example, a clutch guide 51 according to an embodiment), which includes multiple first friction members (for example, separator plates 53 according to an embodiment) and rotates integrally with the first rotating shaft, a second fastening element (for example, a clutch hub 52 according to an embodiment), which includes multiple second friction members (for example, friction plates 54 according to an embodiment) and rotates integrally with the second rotating shaft, a frictional engagement portion (for example, a frictional engagement portion F according to an embodiment) in which the first fastening element and the second fastening element are alternately stacked in the axial direction, and a pressing member (for example, a piston 57 according to an embodiment), which is movable in the axial direction and presses the frictional engagement portion to engage the first friction member and the second friction member together. One of the first fastening element and the second fastening element (for example, a clutch guide 51 according to an embodiment) is provided with the pressing member at one end of the frictional engagement portion in the axial direction. The other of the first fastening element and the second fastening element is supported at another end of the frictional engagement portion in the axial direction by an internal thrust bearing (for example, an internal thrust bearing 31 according to an embodiment) and an external thrust bearing (for example, an external thrust bearing 32 according to an embodiment) that have different diameters.

When two thrust bearings having different diameters support, in the axial direction, the fastening element across from the pressing member with the frictional engagement portion interposed therebetween, the load of the fastening element in the axial direction is supported at multiple points. Here, when the frictional engagement portion is pressed by the pressing force of the pressing member, the fastening element is prevented from being inclined with respect to the axis of rotation, unlike in the case where the load of the fastening element in the axial direction is supported at only one point. This structure can thus prevent the axis of rotation of the fastening element from being inclined relative to the axial direction and prevent noises that can result from the axial inclination.

In the above power transmission system, the position of the external thrust bearing in the radial direction overlaps the position of the pressing member in the radial direction when viewed from the axial direction, i.e., their positions are substantially aligned with each other in the axial direction.

Because the position of the external thrust bearing in the radial direction overlaps the position of the pressing member in the radial direction when viewed from the axial direction, the force exerted from the pressing member to the fastening element through the frictional engagement portion and the force exerted from the external thrust bearing to the fastening element are not misaligned from each other in the radial direction. This structure can thus prevent the axis of the fastening elements from being inclined.

In the above power transmission system, the position of the external thrust bearing in the axial direction overlaps the position of the internal thrust bearing in the axial direction when viewed from the radial direction, i.e., their positions are substantially aligned with each other in the radial direction.

Because the position of the external thrust bearing in the axial direction overlaps the position of the internal thrust bearing in the axial direction when viewed from the radial direction, the size of the device in the axial direction can be reduced.

In the above power transmission system, the internal thrust bearing and the external thrust bearing are thrust needle bearings (for example, thrust needle bearings according to an embodiment).

The internal thrust bearing and the external thrust bearing, which are thrust needle bearings, can effectively support the load in the axial direction.

The wordings and reference signs in the parentheses represent the wordings or reference signs of corresponding components according to an embodiment described below as an example of the disclosure.

The power transmission system according to an aspect of the disclosure can prevent each fastening element from being inclined relative to an axis and prevent noises that can result from the axial inclination.

### BRIEF DESCRIPTION OF THE DRAWINGS

FIG. 1 is a sectional view of clutch devices according to an embodiment.

FIG. 2 illustrates surroundings of a right clutch device according to an embodiment.

FIGS. 3A and 3B illustrate specific effects of disposing thrust bearings, where FIG. 3A illustrates a positional relationship between an external thrust bearing and a piston and FIG. 3B illustrates a positional relationship between the external thrust bearing and an internal thrust bearing.

### DESCRIPTION OF THE PREFERRED EMBODIMENTS

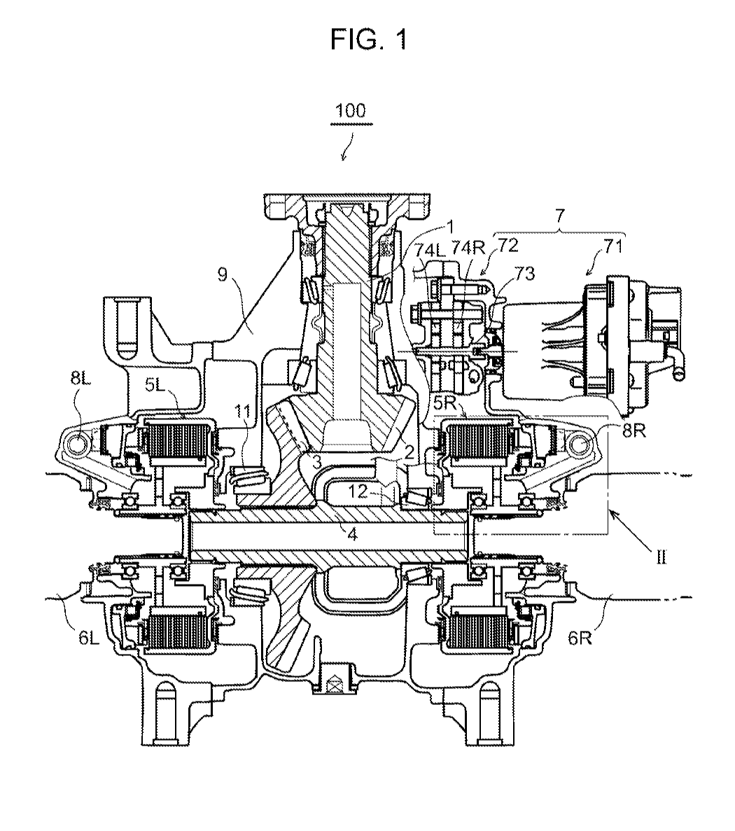

An embodiment of the disclosure is described below in detail with reference to the drawings. FIG. 1 is a sectional view of a related portion of a clutch device 5 according to an embodiment. In the present embodiment, a hydraulic driving-power transmission system 100 is described as an example of a driving-power transmission system 100 including a clutch device 5. The driving-power transmission system 100 is a differential for distributing the rotation of a driving shaft 1 to the left and right driving wheels (not illustrated). The driving-power transmission system 100 includes a driving shaft 1 coupled to a propeller shaft, not illustrated. A driving force from a driving source, not illustrated, is transmitted to the driving shaft 1.

The driving-power transmission system 100 includes a driving bevel gear 2, which rotates integrally with the driving shaft 1, a driven bevel gear 3, engaged with the driving bevel gear 2, and a center shaft 4, disposed perpendicularly to the driving shaft 1 and coupled to the driven bevel gear 3 to rotate integrally with the driven bevel gear 3. The driving-power transmission system 100 also includes left and right clutch devices 5L and 5R, which are disposed on the left and right of the center shaft 4, and left and right output shafts 6L and 6R, which transmit the driving force from the left and right clutch devices 5L and 5R to the left and right driving wheels (not illustrated). The center shaft 4 serves as an input shaft for the left and right clutch devices 5L and 5R, and the left and right output shafts 6L and 6R serve as an output shaft for the left and right clutch devices 5L and 5R.

The driving-power transmission system 100 also includes an automatic oil pump 7, which feeds, to the left and right clutch devices 5L and 5R, an oil for operating and lubricating the devices, left and right pressure regulators 8L and 8R, which regulate the pressure of the oil ejected from the automatic oil pump 7, and a housing 9, which covers the entirety of the clutch devices 5L and 5R.

The entirety of the center shaft 4, to which the driven bevel gear 3 is fixed, rotates integrally. Multiple spline teeth are arranged in the circumferential direction at the left and right ends of the center shaft 4, and spline-coupled to the fastening elements of the corresponding left and right clutch devices 5L and 5R to rotate integrally with the fastening elements.

The center shaft 4 is received by the housing 9 of the differential with tapered roller bearings 11 and 12 interposed therebetween. The tapered roller bearing 11 is fixed in position in the axial direction by being held between the housing 9 and the driven bevel gear 3. The tapered roller bearing 12 is fixed in position in the axial direction by being held between the housing 9 and the center shaft 4.

The automatic oil pump 7 includes a motor 71, which generates rotatory power, and a pump unit 72, which sucks oil from an oil filter using the rotatory power to pump the oil to the left and right clutch devices 5L and 5R with pressure. The pump unit 72 has a dual pump structure including left and right internal gear pumps 74L and 74R coupled in series on a pump shaft 73.

In the present embodiment, for example, the left internal gear pump 74L pumps oil to the left clutch device 5L with pressure, and the right internal gear pump 74R pumps oil to the right clutch device 5R with pressure. The left and right pressure regulators 8L and 8R are disposed substantially symmetrically beside the left and right clutch devices 5L and 5R. The left and right pressure regulators 8L and 8R are electromagnetic pressure regulators.

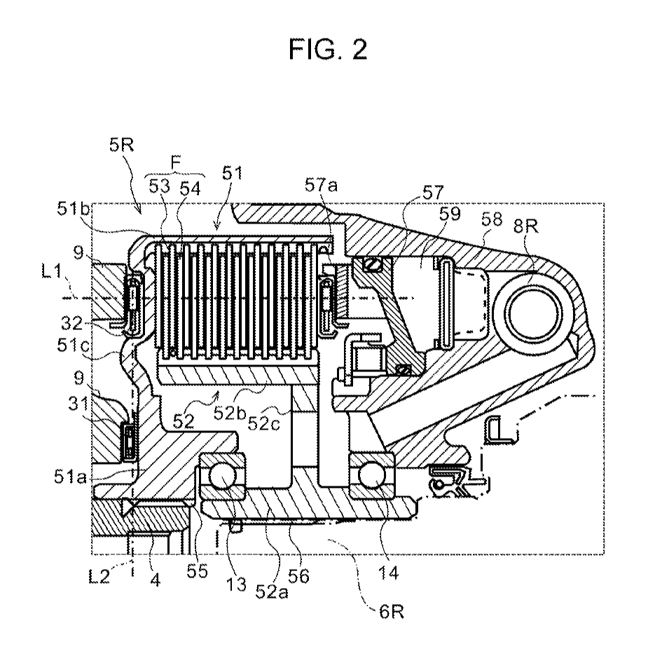

FIG. 2 illustrates the surroundings of the right clutch device 5R according to the present embodiment, and is an enlarged view of portion II in FIG. 1. The left and right clutch devices 5L and 5R are wet multi-plate clutches. The left and right clutch devices 5L and 5R have the same structure. Thus, only the clutch device 5R is described here. In the following description, the subscript L or R representing the left or right is omitted as needed.

As illustrated in FIG. 2, the clutch device 5R includes a clutch guide 51, which is an input rotating member that rotates integrally with the center shaft 4, and a clutch hub 52, which is an output rotating member that rotates integrally with the output shaft 6R.

The clutch guide 51 includes an inner circumferential cylinder 51a, spline-coupled to the center shaft 4, an outer circumferential cylinder 51b, and a hollow disk portion 51c, which couples the inner circumferential cylinder 51a and the outer circumferential cylinder 51b with each other in the radial direction. The clutch guide 51 also includes a spline portion 55 near the base of the inner circumferential cylinder 51a of the clutch guide 51. The spline portion 55 is spline-coupled to the right end of the center shaft 4. In this structure, the clutch guide 51 rotates integrally with the center shaft 4.

The clutch hub 52 includes an inner circumferential cylinder 52a, spline-coupled to the output shaft 6R, an outer circumferential cylinder 52b, and a hollow disk portion 52c, which couples the inner circumferential cylinder 52a and the outer circumferential cylinder 52b in the radial direction. The clutch hub 52 also includes a spline portion 56 near the base of the inner circumferential cylinder 52a of the clutch hub 52. The spline portion 56 is spline-coupled to the output shaft 6R. In this structure, the clutch hub 52 rotates integrally with the output shaft 6R.

The clutch guide 51 and the clutch hub 52 are received with each other and rotatable relative to each other with a ball bearing 13 interposed therebetween. The clutch hub 52, on the other hand, is rotatable relative to a casing 58 of the pressure regulator 8R with a ball bearing 14 interposed therebetween.

On the inner circumferential surface of the outer circumferential cylinder 51b of the clutch guide 51, multiple separator plates 53, serving as friction members, are spline-coupled together at predetermined intervals in the axial direction. On the outer circumferential surface of the outer circumferential cylinder 52b of the clutch hub 52, multiple friction plates 54, serving as friction members, are spline-coupled together at predetermined intervals in the axial direction. The separator plates 53 and the friction plates 54 are alternately stacked in the axial direction to form a frictional engagement portion F.

Each clutch device 5 also includes a piston 57, which presses the frictional engagement portion F. The piston 57 has a hollow annular shape and is movable in the axial direction (to the left in FIG. 2). The piston 57 includes a pressing portion 57a, which presses the frictional engagement portion F. The pressing portion 57a is disposed over the entirety of the hollow annular piston 57 or on at least a portion of the piston 57.

The piston 57 is driven by the hydraulic pressure in a piston chamber 59 and controlled so that the frictional engagement portion F obtains a sufficiently high degree of clutch engagement. When the clutch engages, the pressing portion 57a of the piston 57 presses the frictional engagement portion F, so that the separator plates 53 and the friction plates 54 are fastened with friction.

In the present embodiment, a fastening element across from the piston 57 with the frictional engagement portion F interposed therebetween is the clutch guide 51. When the clutch engages, the pressing force from the pressing portion 57a of the piston 57 is exerted on the clutch guide 51 with the frictional engagement portion F interposed therebetween. In the present embodiment, two thrust bearings are included to support the clutch guide 51 in the axial direction against the pressing force. Specifically, the disk portion 51c of the clutch guide 51 is supported in the axial direction by the internal thrust bearing 31 and the external thrust bearing 32, which have different diameters.

The internal thrust bearing 31 is disposed between the clutch guide 51 and the housing 9, and supports the inner circumferential portion of the disk portion 51c of the clutch guide 51 in the axial direction. The external thrust bearing 32 is disposed between the clutch guide 51 and the housing 9, and has a diameter greater than that of the internal thrust bearing 31. In the present embodiment, the internal thrust bearing 31 and the external thrust bearing 32 are needle bearings.

Now, the positional relationship between the internal thrust bearing 31 and the external thrust bearing 32 is described. The external thrust bearing 32 overlaps the piston 57 in their radial direction positions when viewed from the axial direction. Specifically, as drawn with imaginary line L1 in FIG. 2, the external thrust bearing 32 overlaps the pressing portion 57a, which is part of the piston 57, in the radial direction.

The external thrust bearing 32 overlaps the internal thrust bearing 31 in their axial direction positions when viewed from the radial direction. Specifically, as drawn with imaginary line L2 in FIG. 2, the external thrust bearing 32 overlaps part of the internal thrust bearing 31 in the axial direction.

As described above, in each clutch device 5 according to the present embodiment, the clutch guide 51 across from the piston 57 with the frictional engagement portion F interposed therebetween is supported in the axial direction by two thrust bearings having different diameters, so that the load of the fastening elements in the axial direction is supported at multiple points. When the frictional engagement portion F is pressed with the pressing force of the piston 57, the clutch guide 51 is prevented from being inclined relative to the axis of rotation, unlike in the case where the load of the clutch guide 51 in the axial direction is supported at one point. This structure can thus prevent the axis of the clutch guide 51 from being inclined relative to the axis of rotation and prevent noises that can result from the axial inclination.

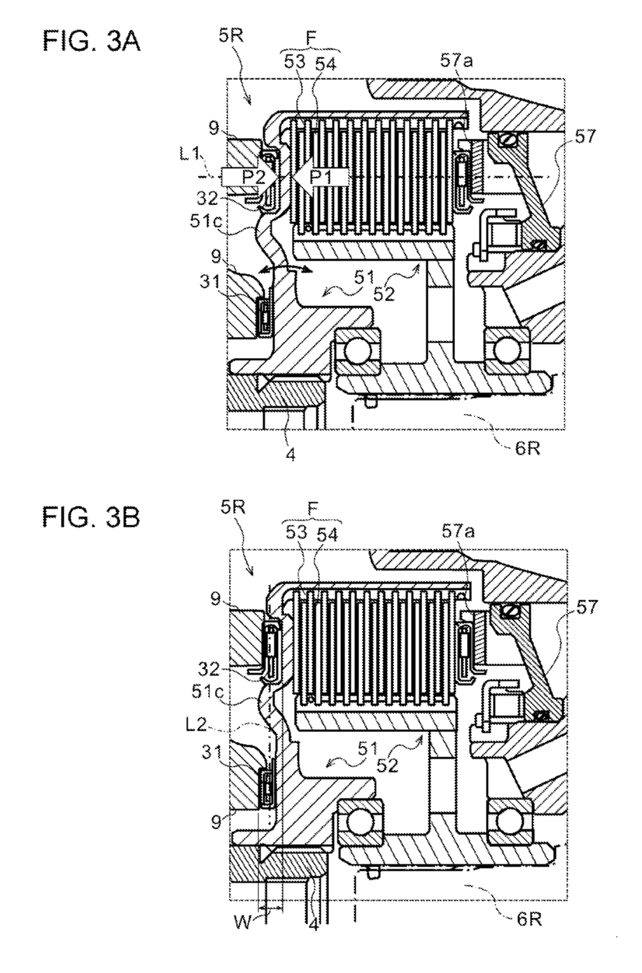

FIGS. 3A and 3B illustrate specific effects of disposing thrust bearings, where FIG. 3A illustrates a positional relationship between the external thrust bearing 32 and the piston 57 and FIG. 3B illustrates a positional relationship between the external thrust bearing 32 and the internal thrust bearing 31.

As indicated with imaginary line L1 in FIG. 3A, the position of the external thrust bearing 32 in the radial direction is disposed so as to overlap the position the piston 57 in the radial direction. Thus, a force P1 exerted from the piston 57 to the clutch guide 51 with the frictional engagement portion F interposed therebetween, and a force P2 exerted from the external thrust bearing 32 to the clutch guide 51 are not shifted to the radial direction of the clutch guide 51. This structure can thus prevent the axis of the clutch guide 51 from being inclined.

As indicated with imaginary line L2 of FIG. 3B, the position of the external thrust bearing 32 in the axial direction is disposed so as to overlap the position of the internal thrust bearing 31 in the axial direction. Thus, a size W of the device in the radial direction can be reduced.

In the above clutch device 5, the internal thrust bearing 31 and the external thrust bearing 32 are thrust needle bearings. This structure can effectively support the load in the axial direction.

Although an embodiment of the present disclosure has been described above, the disclosure is not limited to the above embodiment and may be modified in various manners within the scope of claims, and the scope of technical ideas described in the description and the drawings.

In the above embodiment, thrust needle bearings are described as a preferable example of thrust bearings, but the bearings may have other shapes. For example, the bearings may be other thrust bearings including thrust ball bearings.

What is claimed is:

1. A power transmission system, comprising:
a first rotating shaft and a second rotating shaft, which are axially aligned with each other so as to have a common axis of rotation;
a first fastening element comprising a plurality of first friction members and configured to rotate about the common axis integrally with the first rotating shaft;
a second fastening element comprising a plurality of second friction members and configured to rotate about the common axis integrally with the second rotating shaft;
a frictional engagement portion composed of the first fastening element and the second fastening element in which the first friction members and the second friction members are alternately stacked with one another in a direction of the common axis; and
a pressing member disposed at one end of the frictional engagement portion and movable in the direction of the common axis, the pressing member being configured to press the frictional engagement portion, thereby engaging the first friction members and the second friction members with one another in the direction of the common axis, via which a driving power of the rotation is transmitted from the first rotating shaft to the second rotating shaft,
an internal thrust bearing and an external thrust bearing each disposed at another end of the frictional engagement portion and supporting one of the first fastening element and the second fastening element in the direction of the common axis,
wherein the internal thrust bearing and the external thrust bearing have different diameters.

2. The power transmission system according to claim 1, wherein the external thrust bearing is disposed so as to overlap the pressing member in their radial direction positions when viewed from the direction of the common axis.

3. The power transmission system according to claim 1, wherein the external thrust bearing is disposed so as to overlap the internal thrust bearing in their axial direction positions when viewed from a radial direction.

4. The power transmission system according to claim 1, wherein the internal thrust bearing and the external thrust bearing are needle bearings.
